(19) United States
(12) Patent Application Publication
(10) Pub. No.: US 2002/0143511 A1
(43) Pub. Date: Oct. 3, 2002

(54) Method and computer program product for system design support

(76) Inventor: Mikito Iwamasa, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/059,211

(22) Filed: Jan. 31, 2002

(30) Foreign Application Priority Data
Jan. 31, 2001 (JP) 2001-024491

(51) Int. Cl. G06G 7/62

(52) U.S. Cl. 703/17

(57) ABSTRACT

A system specification in a state transition table form is formed by a set of pieces of state transition unit information each including a current state, event, next state, and information associated with execution control. The information associated with execution control includes a program to be executed/controlled in association with the state transition and execution control contents (start, interrupt end, interrupt pause, end, resume). An execution control table conversion section creates a system specification in an execution control table form on the basis of this state transition table. The execution control table includes a set of pieces of program state transition unit information each including a transition, current execution processing content, its end type, next program, and its start type. A system implementation conversion section creates a system specification described in a system description language and having an executable form on the basis of the execution control table.

### CROSS-REFERENCE TO RELATED APPLICATIONS

This application is based upon and claims the benefit of priority from the prior Japanese Patent Application No. 2001-024491, filed Jan. 31, 2001, the entire contents of which are incorporated herein by reference.

### BACKGROUND OF THE INVENTION

1. Field of the Invention

The present invention relates to a method of supporting design of hardware, software, and a system including both of them in a computer or electronic device.

2. Description of the Related Art

In computer systems, a state transition form has been used as a system analysis technique as represented by an object-oriented technique such as UML (Unified Forming Language) (Note that UML is described in detail in, for example, Hans-Eriksson/Magnus Penker, “UML Guidebook”, complied/translated by Norio Sugimoto, Osamu Ochiai, and Tamiko Takeda, ISBN4-8101-8987-2.) A state transition form is a technique of extracting a plurality of states included in a system and organizing the manners in which the extracted states make transition depending on events and conditions. A conventional procedure is to start system design while referring to the state transition form after system analysis is completed.

To shorten the system development period and improve the design quality, a so-called rapid prototyping function of actually executing a specification and checking it while analyzing it and a seamless coupled function of system analysis and system design are indispensable.

According to the prior art, in consideration of the above situation, techniques of executing the simulation based on a state transition analysis result and converting the simulation into an execution program have been implemented (BetterState). In these techniques, a simulation function and conversion function are implemented by assigning execution programs to an action to be executed instantaneously at a state transition and an activity to be executed when the system stays in a state.

A state transition form is based on a premise that the execution of an action is instantaneously completed. Assigning an execution processing content demanding a predetermined execution time longer than 0, typified by a computer program, to an action is mismatching in terms of semantics. In this case, the consistency of the overall behavior of the system cannot be guaranteed.

In addition, since an activity exhibits one-to-one correspondence between a state and processing, the flexibility of a description in a state transition form, i.e., executing different actions even in the same states concerning a transition destination or source if different transitions take place, is impaired. This limits the description range. As a consequence, with the technique of assigning execution processing contents such as computer programs to actions and activities in the state transition form, an accurate simulation cannot be executed and flexible system design cannot be performed.

### BRIEF SUMMARY OF THE INVENTION

The present invention has been made in consideration of the above situation, and has as its object to provide a system design support method and computer program product which can shorten a system development period and improve design quality by totally supporting processing from system analysis to design and supporting accurate system design in accordance with the system analysis result.

According to one aspect of the present invention, there is provide a system design support method comprising: generating a first system specification described in a state transition table form using a state transition unit which includes information relating to an execution control over the system; generating a second system specification described in an execution control table form which includes an execution processing content in the a system as a set of state transition units, based on the first system; and converting the second system specification described in an execution control table form to a third system specification having an executable form described in a system description language.

### BRIEF DESCRIPTION OF THE SEVERAL VIEWS OF THE DRAWING

FIG. 1 is a block diagram showing an arrangement of a system design support apparatus according to an embodiment of the present invention;

FIG. 2 is a flow chart showing a procedure in the execution control table conversion section of the system design support apparatus according to the embodiment;

FIG. 3 is a flow chart showing a procedure in the system implementation conversion section of the system design support apparatus according to the embodiment;

FIG. 4 is a view showing a specification in the state transition table form;

FIG. 5 is a view for explaining conversion from a specification in the state transition table form into a specification in the execution control table form;

FIG. 6 is a view for explaining conversion from a specification in the state transition table form into a specification in the execution control table form;

FIG. 7 is a view showing a specification in the state transition table form;

FIG. 8 is a view showing a specification in the execution control table form;

FIG. 9 is a view for explaining conversion from a specification in the execution control table form into a specification in the system description language form;

FIG. 10 is a view showing a specification in the system description language form; and

FIG. 11 is a view showing a system design support apparatus.

### DETAILED DESCRIPTION OF THE INVENTION

An embodiment of the present invention will be described below with reference to the views of the accompanying drawing.

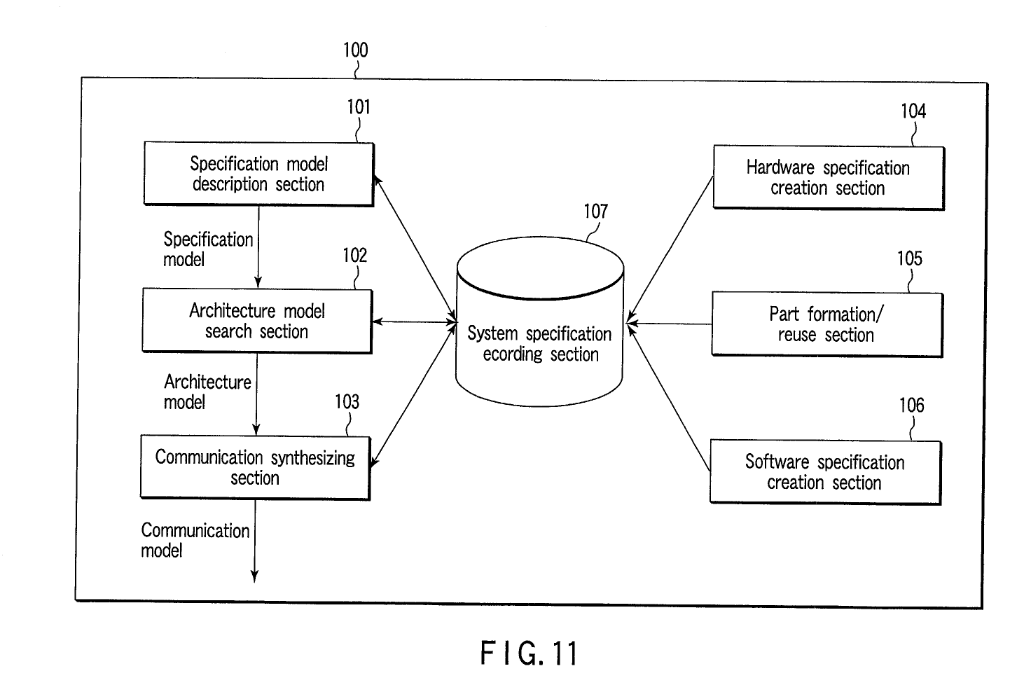

A system design support apparatus 100 shown in FIG. 11 is comprised of a specification model description section 101, system specification recording section 107, architecture search section 102, communication synthesizing section 103, hardware specification creation section 104, part formation/reuse section 105, and software specification creation section 106.

The system design support apparatus 100 of this embodiment handles at system level, e.g., a specification for software executed by a computer, a specification for hardware combined with semiconductor devices and the like, a specification for an incorporated system constituted by a combination of software and hardware, and a specification for a business process such as a work flow.

The specification model description section 101, which is used to design a specification model comprised of specifications for calculation and communication in such specifications at system level, is a section for supporting a designer to describe specifications. When the designer describes specifications for calculation contents and communication contents according to a predetermined specification description form, a specification description model is created. This specification description model includes a specification structure to be described later. Examples of the specification description form are a structured text form represented by a structured programming language, a structural chart form using graphs, and a table form using tables.

The architecture search section 102 divides a partial structure of a supplied specification description model into elements and distributing the elements to architecture elements while maintaining the contents of the specification in consideration of an architecture (the arrangement of a hardware/software implementation environment). More specifically, parts (the constituent elements of a specification description model) constituting specifications for calculation contents and communication contents designed by the specification model description section 101 are assigned to architecture elements (creation of an architecture model).

The communication synthesizing section 103 synthesizes communication procedures between specification elements on an architecture. More specifically, the communication synthesizing section 103 inserts a communication procedure (protocol) between communication specification elements distributed by the architecture search section 102 and performs protocol conversion (rearrangement of a communication procedure) to match with a communication procedure in which the communication content specification is inserted (creation of a communication model).

The system specification recording section 107 associates the specification model created by the specification model description section 101, the architecture model created by the architecture search section 102, and the communication model created by the communication synthesizing section 103 with each other, and records the resultant data as a system specification.

The hardware specification creation section 104 creates a hardware specification from the system specification recorded on the system specification recording section 107. The software specification creation section 106 creates a software specification from the system specification recorded on the system specification recording section 107.

The part formation/reuse section 105 forms the system specification recorded on the system specification recording section 107 into parts and provides them for reuse in design processes in the specification model description section 101, architecture search section 102, and communication synthesizing section 103.

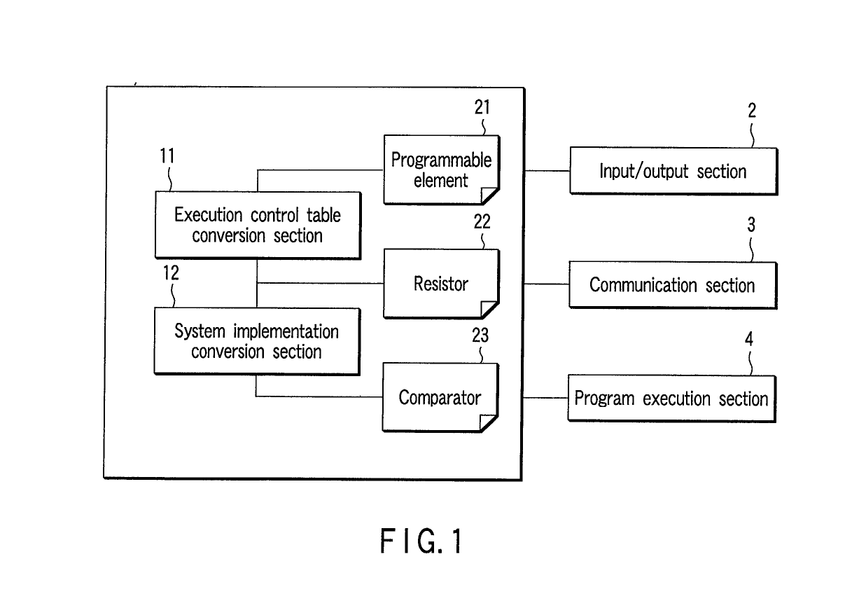

FIG. 1 shows an arrangement of a system design support apparatus according to an embodiment of the present invention.

As shown in FIG. 1, this system design support apparatus is comprised of a system creation section 1, input/output section 2, and storage section (not shown) The system creation section 1 includes an execution control table conversion section 11 and system implementation conversion section 12. The input/output section 2 exchanges data and instructions with external units. The storage section (not shown) stores a specification (21) as an input described in a state transition table form, a specification (22) as an intermediate state described in an execution control table form, a specification (23) as an output described in a system description language, a conversion rule, a specification integration rule, and the like. This system further includes a communication section 3 and program execution section 4, as needed.

The execution control table conversion section 11 of the system implementation conversion section 12 converts the specification (21) described in the state transition table form into the specification (22) described in the execution control table form.

The system implementation conversion section 12 converts the specification (23) described in the execution control table form into the specification (23) described in the system description language.

This system design support apparatus can be implemented by, for example, executing a program (system design support software) for practicing the present invention on a computer.

The semantic contents of the “specification described in the state transition table form (specification in the state transition table form)” and the “specification described in the execution control table form (specification in the execution control table form)” will be described first. Processing in the execution control table conversion section 11 which converts the former into the latter will be described next.

### Specification in State Transition Table Form

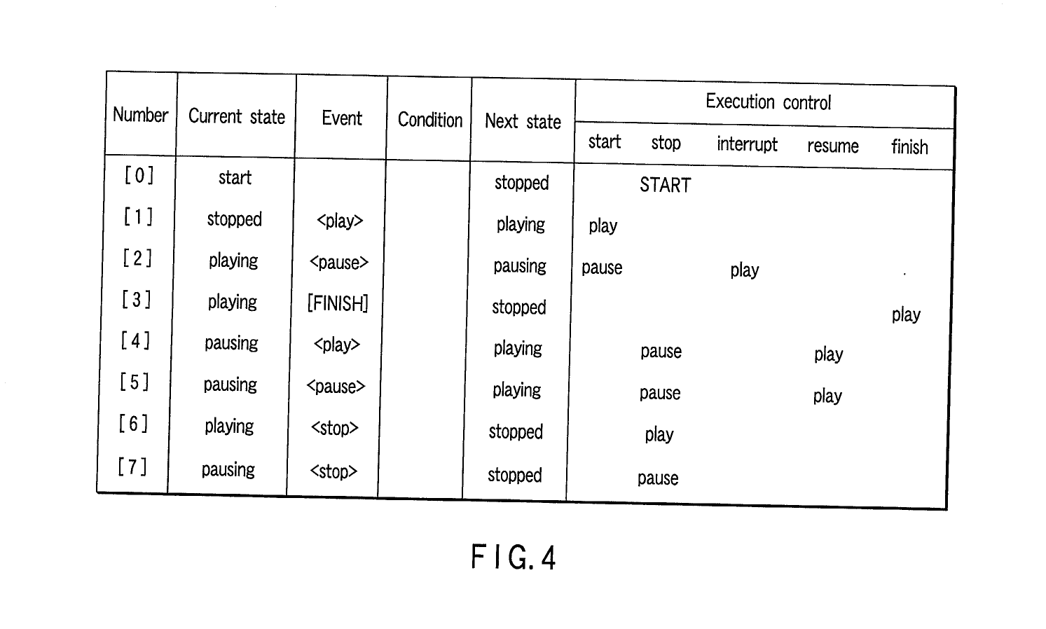

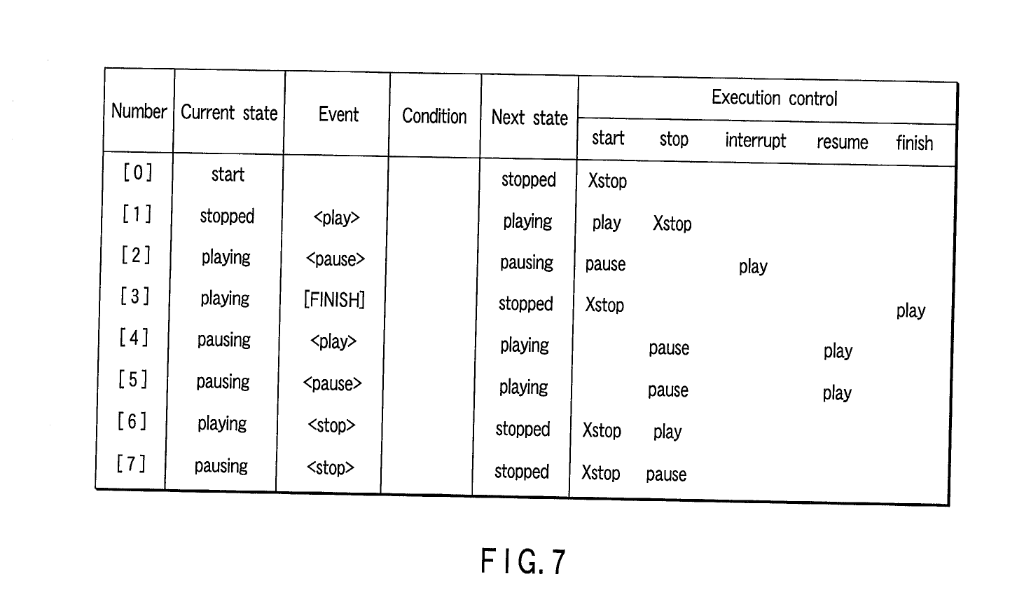

A specification in the state transition table form is a mechanism for describing the behavior of a system with the definitions of a finite number of states which the system can take and transitions between the states due to “events” (see the specific example shown in FIG. 4 or 7).

A specification in the state transition table form is constituted by, for example, a set of state 10 transition units described below.

state transition unit−(transition number, current state, event, transition condition, action, next state, execution control)

Note that state transition units can also expressed as follows: state transition unit=(transition number, current state, event, transition condition, next state, execution control); state transition unit=(transition number, current state, event, action, next state, execution control); state transition unit=(transition number, current state, event, next state, execution control); and the like.

Each state transition unit identified by a transition number represents part of the behavior of the system that when the system is in “current state”, if “event” occurs and “transition condition” is satisfied, “action” is executed to make a transition to “next state”. In this case, the action at the time of a transition is instantaneously completed. “Execution control” is an item associated with execution control of a corresponding program (execution processing contents) upon occurrence of a transition.

For example, the state transition unit with number “2” in the specific example of the CD player shown in FIG. 4 (action is omitted) represents the following specification. When a pause event (pause) occurs in a playback state (playing), an interruption (interrupt) is caused in a play program to temporarily stop it. At the same time, a pause program is started (start) to make a transition to a pause state (pause).

As special states, an initial state (start) and an end state (end) are prepared.

An initial state (start) is a pointer which indicates the initial state of the system upon activation of the system. The corresponding instruction is expressed as one state transition unit as follows:

(start, -, -, -, initial state)

An end state (end) is a virtual state to which a transition is made at the end.

The state transition table form allows hierarchical description. More specifically, a set of lower-level state transition units can be grouped into one hierarchical state X, and a specification in the state transition table form including X as one state can be defined on a higher level. On a higher level, when a transition is made to the hierarchical state X, a transition is made to the state designated in the initial state (start) on the lower level of X.

### Connection of Transitions

In the state transition table form, “transition” from a current state to a next state is defined. The next state becomes the current state at the next time. For this reason, an adjacency relationship having directivity holds between state transition units through the same “state”. Transitions which satisfy this adjacency relationship will be called “connected transitions” A transition connection relationship is a partial order relation conforming to the directivity of transitions, and a transitivity rule holds. If, for example, transition A is connected to transition B, and transition B is connected to transition C, transitions A and C have a connection relationship.

A transition connection along the same direction as the transition direction will be called a forward connection, and the opposite direction will be called a reverse connection. If, for example, transitions A and B are connected to each other, and the connection direction is from transition A to transition B, the connection from transition A to transition B is a forward connection. A connection from transition B to transition A is a reverse connection.

### Details of “Execution Control”

As an item for “execution control” in the state transition table form, a detailed item associated with execution control on a program is prepared. A processing content unit (program) is input to this detailed item. In this case, the detailed item is comprised of at least a start element (start), stop element (stop), interrupt pause element (interrupt), program end element (finish), restoration of pause (resume), and an item as a combination of these elements.

Note that the completion of a processing content unit (program) will be regarded as an event. This event will be called an end event, in particular, and written as “FINISH” in the state transition table form (see the state transition unit with number “3” in FIG. 4).

### Specification of Execution Control Table Form

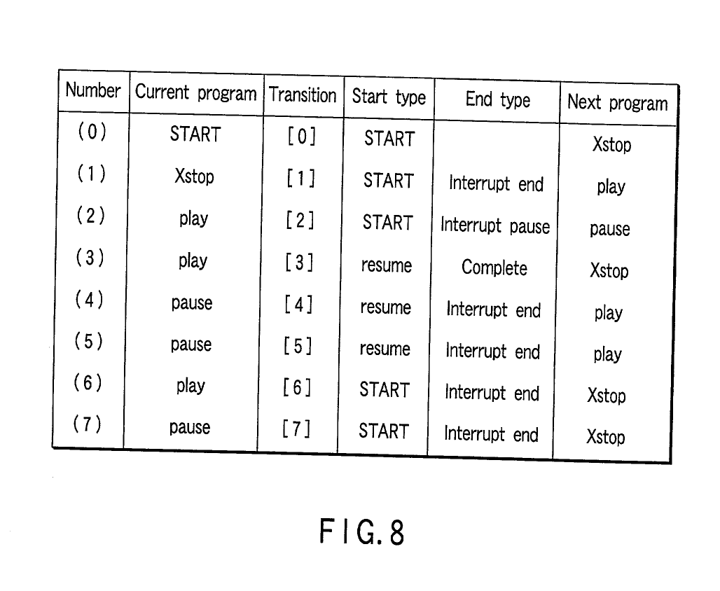

A specification in the execution control table form is a mechanism for describing the behavior of a system by defining an execution processing content units such as programs in the system and the manners in which execution control (start, stop, interrupt) is performed on these processing content units (programs) upon state transitions (see the specific example shown in FIG. 8).

A specification in the execution control table form is comprised of a set of program state transition units indicating how processing content units (programs) are switched upon state transitions.

A program state transition unit is a table for associating a change in the execution state (standby state, execution state, end state, pause state) of a processing content unit (program) due to a state transition with changes in the execution states of other programs.

For example, a program state transition unit is expressed in a table form as follows.

program state transition unit−(number, current program, transition, movement type, end type, next program)

Each program state transition unit represents the following specification. When “transition” occurs during execution of “current program”, execution control is performed on “current program” in accordance with “end type”. “Next program” is then started in accordance with “start type”.

For example, the program state transition unit with number (2) in the specific example of the CD player in FIG. 8 represents the following specification. When transition [2] occurs during execution of a current program (play), the current program (play) is interrupted/paused, and the current program (pause) is started.

There are two start types, namely “start” and “resume”.

“Start” indicates that a program is started.

“Resume” indicates that execution of a program that has been paused is resumed.

There are three end types, namely “interrupt end”, “complete”, and “interrupt pause”.

“Complete” indicates that when a preceding program is completed, the next program is stated.

“Interrupt end” indicates that when a transition occurs during executing of a current program, the current program is forcibly ended, and a next program is started.

“Interrupt pause” indicates that when a transition occurs during execution of a current program, the current program is paused, and a next program is started.

When, for example, a plurality of next programs are defined with respect to a combination of identical units (current program, transition X, movement type Y, end type Z) like

(current program A, transition X, movement type Y, end type Z, next program B)

(current program A, transition X, movement type Y, end type Z, next program C)

the plurality of next programs (B and C in the above case) are concurrently started upon transition X.

Note that like a specification in the state transition table form, a specification in the execution control table form includes a start state (start) and end state (end) as special program states.

A specification in the execution control table form can be hierarchically described. More specifically, a set of lower-level program state transition units can be grouped into one hierarchical state X, and a specification in the program state transition table form including X as one execution processing content (program) can be defined on a higher level. On a higher level, when a transition is made to the hierarchical state X, a program state designated by an initial state (start) is executed on a lower level of X. If “interrupt end” and “interrupt pause” is performed with respect to the hierarchical X, “interrupt end” and “interrupt pause” are performed with respect to all the programs on a lower level of X.

### Processing in Execution Control Table Conversion Section 11

Processing in the execution control table conversion section 11 will be described.

The execution control table conversion section 11 converts a state transition table into the execution control table form on the basis of information of execution control items (start, stop, interrupt, resume, finish) in the state transition table form.

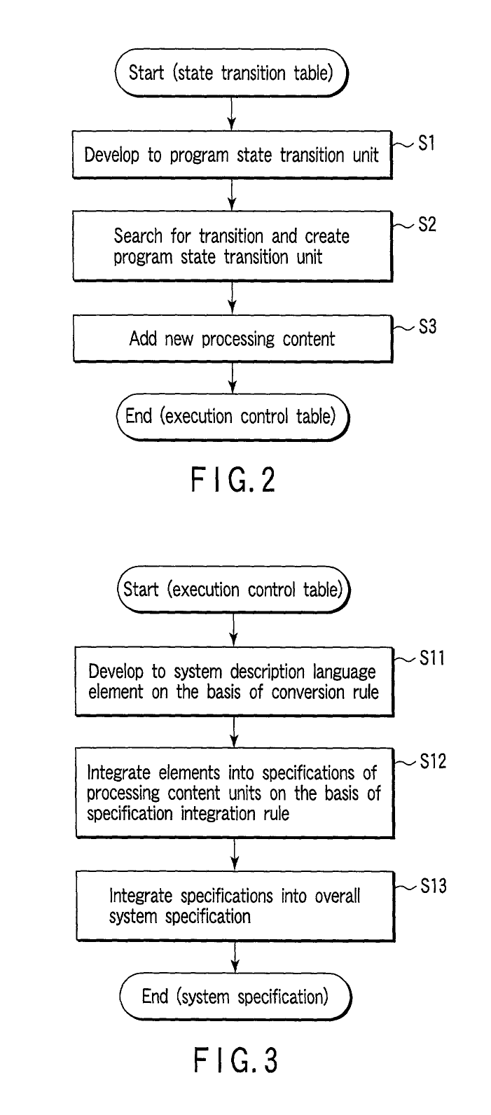

FIG. 2 shows a procedure in the execution control table conversion section 11.

### Step S1: Development to Program State Transition Unit

With regard to each state transition unit in a state transition table, a combination of <current program, next program> is developed, by which one program is selected from items (start, resume) associated with the start of execution control to be set as “current program”, and one program is selected from items (stop, finish, interrupt) associated with the end of execution control to be obtained as “next program”.

In accordance with execution control items (start, resume) originating from the current program, “start type” is determined as follows:

for start, “start type”=start

for resume, “start type”=resume

In accordance with execution control items (FINISH, interrupt, stop) originating from the next program, “end type” is determined as follows:

for stop, “end type”=interrupt end

for finish, “end type”=complete

for interrupt, “end type”=interrupt pause

In addition, a transition number is assigned to “transition”.

With regard to one state transition unit, one or more program state transition units are developed.

By performing the above processing for all state transition units included in the state transition table, a set of program state transition units, i.e., an execution control table, is obtained.

### Step S2: Searching for Transition and Creating Program State Transition Unit

Assume that when a state transition table form is converted into an execution control table form, a given one of program state units

(current program, transition, start type, end type, next program)

has no current program or next program. In this case, program state transition units having “transitions” with transition numbers exhibiting

the forward direction relative to “transition” if no “next program” item exists;

the reverse direction relative to “transition” if no “current program” item exists

are searched by referring to the connection relationship between transitions in the state transition table. This processing is repeated until a processing unit (program) corresponding to “next program” or “current program” is searched out.

When such a program is found, a new program state transition unit including this program as “next program” or “current program” is created, and program state transition units in the process of the search are deleted. At this time, “transition” of the newly created program state transition unit is a transition sequence of all the transitions in the search processing.

### Step S3: Addition of New Processing Contents

A new execution process (program) interposed between the found program an the original program is added by properly inserting it in start and end portions in consideration of the continuity of transitions.

A state transition table is converted into an execution control table in accordance with the following procedure.

### Difference Between State Transition Table Form and Execution Control Form

In the state transition table form, the behavior of a system is described with state changes corresponding to events. This is an important description in a system analysis process. In the system design stage, execution processing contents such as computer programs are identified instead of states this time on the basis of the system analysis result, and a control scheme is designed, which is associated with the manners in which specific execution processing contents are started and stopped at specific timings.

The state transition table form uses a known method of describing processing contents in a state transition as an action to be executed at a transition and an activity to be executed during a state stay, as represented by the StateChart scheme. However, the state transition form is based on a premise that the execution of an action is instantaneously completed. Assigning an execution processing content demanding a predetermined execution time longer than 0, typified by a computer program, to a state transition is mismatching in terms of semantics. In this case, the consistency of the overall behavior of the system cannot be guaranteed.

In addition, since an activity exhibits one-to-one correspondence between a state and processing, the flexibility of a description in a state transition form, i.e., executing different actions even in the same states concerning a transition destination or source if different transitions take place, is impaired. This limits the description range.

As a consequence, with the technique of assigning execution processing contents such as computer programs to actions and activities in the state transition form, an accurate simulation cannot be executed and flexible system design cannot be performed.

The execution control table form is a new scheme of defining execution control on processing contents instead of state transitions.

The system implementation conversion section 12 which converts a specification described in the execution control table form into a specification described in the system description language will be described next.

The semantic contents of “specification described in system description language” will be described first. Processing in the system implementation conversion section 12 which converts “specification described in execution control table form” into “specification described in system description language” will be described next.

### System Description Language

The system description language is a language for describing operation specifications of processing execution in a system implemented by a computer or electronic part circuit.

This description language has at least means for describing parallel processing, interrupt processing, synchronous processing, repetitive execution processing, and sequential execution processing, and can describe the specifications of a system with a hierarchical relationship using these processing elements. This language can also convert such specifications into those in a form that can be executed on a computer or a device incorporating an electronic part by using an appropriate implementation conversion unit. In this case, the implementation conversion unit corresponds to a conversion unit called a compiler in a system implemented by software in a computer.

### SpecC Language

As a typical system description language, specification description language SpecC is available. For example, SpecC is described in detail in “SpecC: Specification Language and Methodology”, Daniel D. Gajski, Kluwer Academic Publishers, Dordrecht, ISBNO-7923-7822-9.

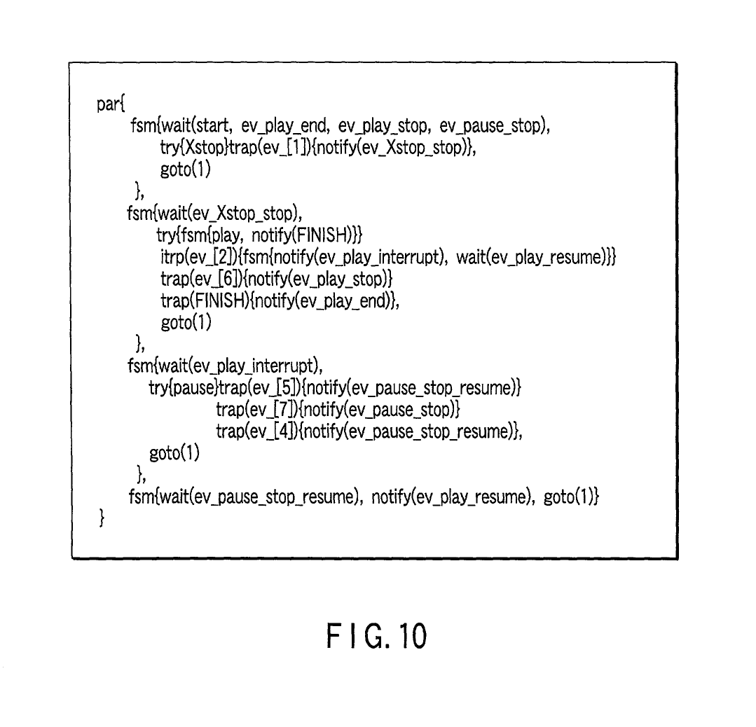

SpecC is a specification description language having special language elements, par (parallel), fsm (repetitive+sequential), try/trap/interrupt (interrupt), and notify/wait (synchronous) to C/C++ (see the specific example shown in FIG. 10).

The following description exemplifies a case where a specification described in the system description language is expressed in the following form based on the language elements of SpecC.

par{A, B, C}

According to this language element, A, B, and C are concurrently executed.

fsm{{1, A, goto(2)},

{2, B, flg==3: goto(1), flg==1: goto(2)},

}

In this case, each element of fsm is constituted by any one of the following:

{label, processing content, {condition: transition upon establishment of condition}, . . . },

{label, processing content, transition upon completion of processing, . . . },

{label, processing content}, and

processing content

These elements are sequentially executed from the left unless otherwise specified. If there is no transition label item, {label, processing content} executes the next fsm element upon completion of the processing contents. Assume that label=1 or the leftmost fsm element is executed first. A transition is expressed by “goto(x): X is label number”. For example, goto(1) indicates that the flow returns to the first fsm element.

The above case indicates the following operation. When A is executed and completed, B is executed. When B is completed, A is executed if the value of the variable flg is 3, and B is executed if the value is 1.

As in the following example, an element without any label can be regarded as a simplified form of given execution control using a label.

fsm{A, B, C}=fsm{{1, A, goto(2)}, {2, B, goto(3)}, {3, . . . }·try{A}trap(ev1) {B}itrp(ev2) {C}. . .

In the case of this language element, A is executed first. If event ev1 occurs during execution of A, A is forcibly ended, and B is executed. If event ev2 occurs during execution of A, A is paused, and C is executed. When C is completed, A is resumed.

Note that each of trap(e) {X} and itrp(e2) {Y} may be more than one.

wait(ev)

This is synchronous processing which waits for the occurrence of event ev.

notify(ev)

This is synchronous processing that causes event ev.

flg=X

This is a substitution of a value into variable flg.

flg==X

This is condition determination.

Assume that a hierarchical structure indicates that processing contents are further developed into a detailed specification described in the system description language.

The following is a specification sample having a hierarchical structure:

par{

fsm{A, wait (ev2), B}
try{C}trap (ev1) {notify (ev2) }

}

This specification sample can be written in a natural language as follows:

“A and C are concurrently executed first. When event ev1 arrives, C is forcibly ended, and event ev2 is generated. If A has been completed at the time of occurrence of ev2, B is synchronously started.”

### Processing in System Implementation Conversion Section 12

Processing in the system implementation conversion section 12 will be described next.

As described above, the system implementation conversion section 12 converts a specification described in the execution control table form into a specification described in the system description language.

FIG. 3 shows a procedure in the system implementation conversion section 12.

### Step S11: Development into System Description Language Element by Conversion Rule

A conversion rule is a rule for developing a program state transition unit (one line) in an execution control table into a specification in the system description language.

The system implementation conversion section 12 develops all program state transition units in the execution control table into a specification in the system description language according to the conversion rule.

According to some conversion rules, for example, in the processing content of “next program”

(current program A, transition T, movement type, end type, next program B)

the following rules are applied to combinations of <start type, end type> to develop them into part of a specification described in the system description language. Note that “ev_XX” in the following description represents an event.

In the case of <start, interrupt end>, this combination is developed into fsm{wait (ev_A_stop), B, goto(1)}and try{A}trap{ev_T}{notify(ev_A_stop)}

In the case of <start, complete>, this combination is developed into fsm{wait(ev_A_end), B, goto(1)} and fsm{A, notify(ev_A_end), goto(1)}

In the case of <start, interrupt pause>, this combination is developed into fsm{wait(ev_A_interrupt), B, goto(1)} and try{A}itrp{ev_T}{fsm{notify(ev_A_interrupt), wait (ev_A_resume)}};

In the case of <resume, complete>, this combination is developed into fsm{wait(ev_A_end), notify(ev_B_resume), goto(1)} and

fsm{A, notify(ev_A_end), goto(1)}

In the case of <resume, interrupt end>, this combination is developed into fsm{wait(ev_A_stop_resume), notify(ev_B_resume), goto(1)} and

try{A}itrp{ev_T} {notify(ev_A_stop_resume)}

The system implementation conversion section 12 executes such development for all the program state transition units included in the execution control table.

### Step S12: Integrating Processing Content Units into Specification

A set of portions of a developed specification are integrated into the following form with particular emphasis on each of processing contents (A, B, . . . )

fsm{wait for start, processing content, processing after completion, transition} or

fsm{wait for start, processing content, transition}

Assume that “wait for start” takes the following forms:

wait for start=par{wait(synchronous event 1),

wait(synchronous event 2)} or

wait for start=wait (synchronous event 1, synchronous 2)

Assume that “processing content” takes the form of a list formed from

processing content=processing contents A, B, . . . or

processing content=try{A}trap(transition event) {processing after transition} and =try{A} itrp(transition event) {processing after transition}

Processing after completion takes the following form:

processing after completion=notify(synchronous event)

In addition, a transition takes the following form:

transition=goto(X), where X is label

In this case, the specification descriptions developed according to the conversion rule are classified as follows for the sake of descriptive convenience.

(1) Start element fsm

An element having the following form:

fsm{wait(X), B, goto(1)}

with respect to processing content B will be called start element fsm.

(2) End element try

An element having the following form:

try{X} trap(e) {Y}

try{X} itrp(e) {Y}

with respect to processing content X will be called end element try.

(3) End element fsm

An element having the following form:

fsm{X, notify(e), goto(1)}

with respect to processing contents X will be called end element fsm.

[Integration of start element fsm and end element fsm]

fsm{wait(e), A, goto(1)}

fsm{A, notify(f), goto(1)}

are integrated into

fsm{wait(e), A, notify(f), goto(1)}

[Integration of start elements fsm]

fsm{wait(A), B, goto(1)}

fsm{wait(C), B, goto(1)}

are integrated into

fsm{wait(A, C), B, goto(1)}

If a plurality of elements wait exist at the start, they are integrated into an OR (having at least one event).

[Integration of end elements try]

try{A} trap(e1) {C}

try{A} trap(e2) {D}

try{A} trap(e3) {E}

are integrated into

try{A} trap(e1) {C} trap(e2) {D} trap(e3) {E}

[Integration of start element fsm and end element try]

fsm{wait(A), B, goto(1)}

try{B}trap(e) {C}

are integrated into

fsm{wait(A), try{B} trap(e) {C}, goto(1)}

Likewise,

fsm{wait(A), B, goto(1)}

try{B} itrp(e) {C}

are integrated into

fsm{wait(A), try{B} itrp(e) {C}, goto(1)}

[Integration of end elements fsm and try]

fsm{A, notify(end), goto(1)}

try{B} trap(e) {C}

are integrated into

fsm{try{fsm{A, notify(FINISH)}}}

trap(e) {C}

trap(FINISH) {notify} (end)}

,

goto(1)}

In this case, FINISH is an event that notifies the end of A, which is detected by trap(FINISH), and end event end of A is finally issued.

### Step S13: Integrating Specifications into Overall System Specification

When the specification portions obtained in step S12 are combined into a parallel execution structure (par), a final system specification is completed.

system specification=

par{

fsm{wait for start, processing content A,

processing after completion},

fsm{wait for start, processing content B,

processing after completion},

fsm{wait for start, processing content C,

processing after conpletion},

}

The specification described in the execution control table form is converted into a specification described in the system description language by the above procedure.

Note that the conversion rule used in this procedure is an example, and other conversion rules can be used to optimize a created system description language (e.g., minimize the size of a description) and facilitate actual calculations and implementation by a computer.

In addition, an obtained system specification can be converted into a desired structure by using, for example, a means for optimizing conversion while maintaining a function.

This embodiment will be described in more detail by taking the design of a compact disk playing apparatus (CD player) as an example. In this case, a CD player is an apparatus which controls a playing machine by pressing a play, pause, and stop buttons as control buttons (hardware buttons or buttons on a GUI window). Note that <XXX> indicates an event in which a control button XXX is pressed.

Assuming that the CD player has three states, namely stopped (a state where the player is stopped), playing (a state where the player is being played), and pausing (a state where the player is being paused), the specification of the CD player is described in the state transition table form including the operation of pressing a control button as an event. FIG. 4 shows a state transition table in this case.

Each row of the state transition table describes to which state a current state makes a transition when an event occurs. The details of the execution control item include start, stop, interrupt, and resume, in which processing content units (programs) stating how starting (start), interrupting/ending (stop), interrupting/pausing (interrupt), and restoring from interrupt pause (resume) are performed upon occurrence of a transition are defined. There are two types of processing content units in the CD player, namely play (execution of a play) and pause (execution of a pause).

Finish indicates that the end of processing contents under execution is used as an event. With regard to transition number [3], the end of a play is defined as an event that causes a transition from playing to stopped. At this time, in the event column, [FINISH] explicitly indicates an end event.

In addition, when a transition is made from a start state (transition [0]), a start program state (start) is forcibly ended.

### Conversion to Execution Control

The execution control table conversion section 11 converts a state transition table into an execution control table.

First of all, following the procedure in step S1 in FIG. 2, state transition units having processing contents (programs) in both items associated with starts (start, resume) and items associated with ends (stop, finish, interrupt) are selected and developed as a combination of <current program, next program>.

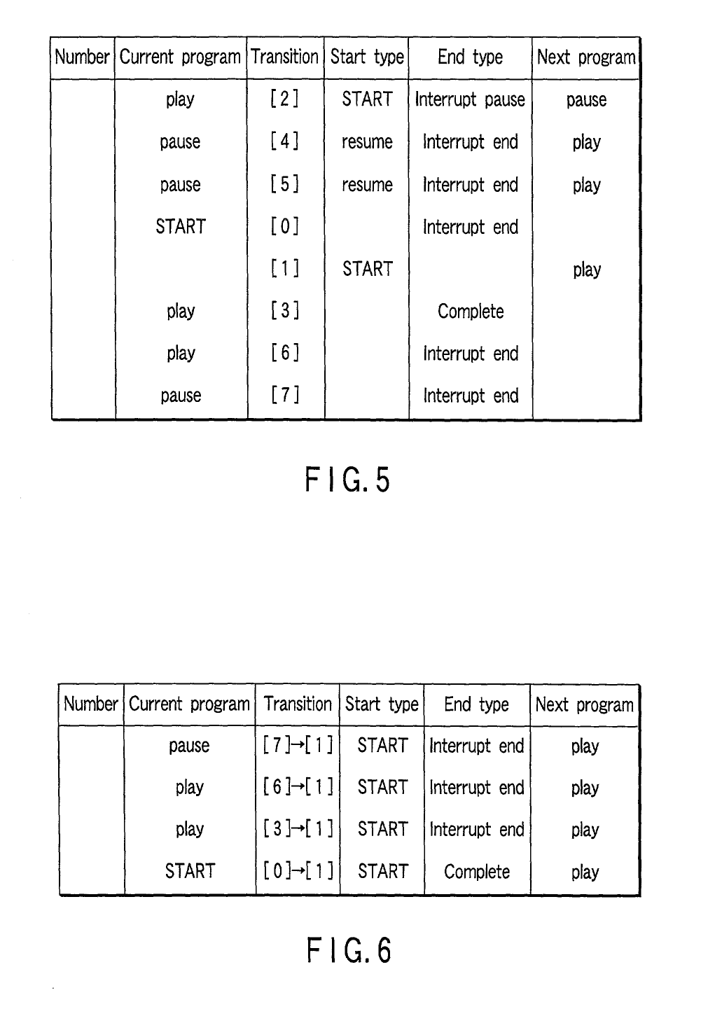

Since transitions [2], [4], and [5] have both items associated with starts and items associated with ends, program state transition units are developed first in the manner shown in FIG. 5.

Following the procedure in step S2 in FIG. 2, connection relationships concerning transitions are tracked. As a consequence, with respect to transitions [7], [3], [6], and [0] having no [next program], the respective transition connections are referred to in the forward direction. In the case of transition [7], for example, it is connected to transition [1] in the forward direction through a stopped state, and transition [1] has [next program]. Therefore, the new program state transition shown in FIG. 6 is obtained. In the cases of transitions [3], [6], and [0] as well, the new program state transitions shown in FIG. 6 are obtained.

Following the procedure in step S3 in FIG. 2, new processing contents (Xstop) are inserted between transitions [0], [3], [6], [7], and [1].

In consideration of the start and end, these processing contents are respectively inserted in the start item of transition [1] in the state transition table and the stop items of transitions [7], [3], [6], and [0] in the state transition table.

FIG. 7 shows the state transition table (corresponding to the execution control table finally obtained) obtained by inserting Xstop in the state transition table in FIG. 4. FIG. 8 shows the execution control table finally obtained.

### Conversion to System Specification

The system implementation conversion section 12 converts a specification in the execution control table form into a specification in the system description language.

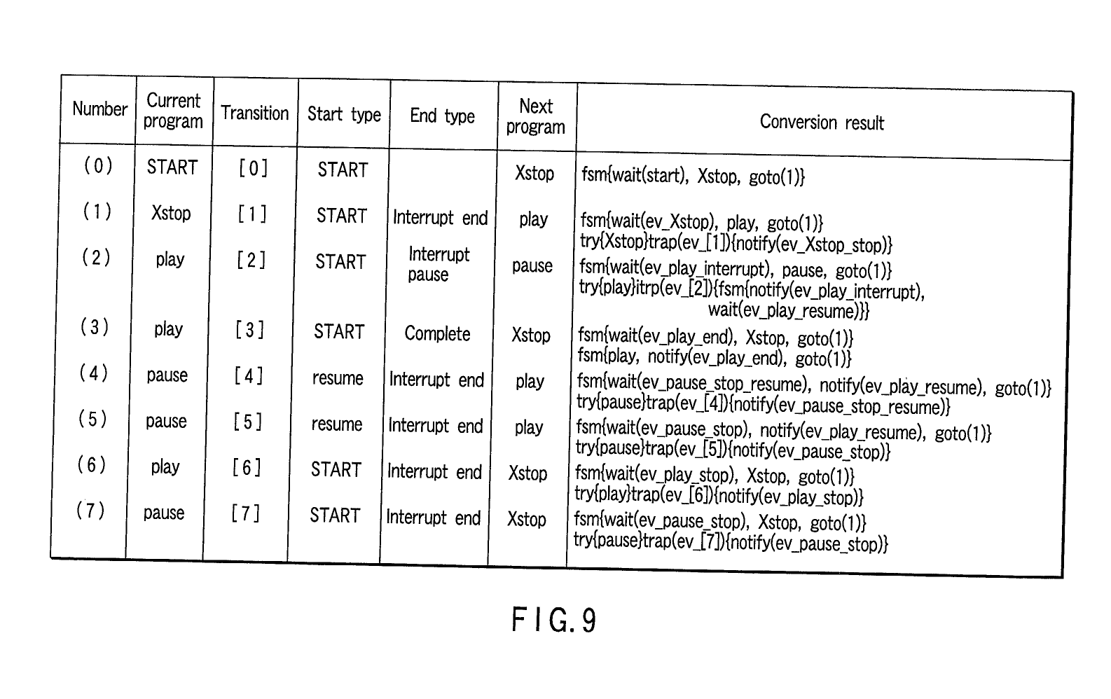

First of all, following the procedure in step S11 in FIG. 3 and a conversion rule, each program state transition unit is converted into a unit in the SpecC form. FIG. 9 shows the result.

These units are complied for the respective processing contents (play, pause, Xstop) as follows:

play

fsm{wait(ev_Xstop_stop), play, goto(1)}

fsm{play,notify(ev_play_end), goto(1)}

try{play}itrp(ev_{—}[2]) {fsm{notify(ev_play_interrupt), wait(ev_play_resume)}}

try{play} trap(ev_{—}[6]) {notify(ev_play_stop)}

pause

fsm{wait(ev_play_interrupt),pause,goto(1)}

try{pause}trap(ev_{—}[5]){notify(ev_pause_stop)}

try{pause}trap(ev_{—}[7]){notify(ev_pause_stop)}

try{pause}trap(ev_{—}[4]) {notify(ev_pause_stop_resume)}

Xstop

fsm{wait(start),Xstop,goto(1)}

fsm{wait(ev_play_end),Xstop,goto(1)}

fsm{wait(ev_play_stop),Xstop,goto(1)}

fsm{wait(ev_pause_stop),Xstop,goto(1)}

try{Xstop}trap(ev_{—}[1]) {notify(ev_Xstop_stop)}

OTHERS

fsm{wait(ev_pause_stop_resume),

notify(ev_play_resume),goto(1)}

fsm{wait(ev_pause_stop_resume),

notify(ev_play_resume),goto(1)}

These units are then integrated according to the procedure in step S12 in FIG. 3 and a specification integration rule. The following is the result.

Xstop

fsm{wait(start),Xstop,goto(1)}

fsm{wait(ev_play_end),Xstop,goto(1)}

fsm{wait(ev_play_stop),Xstop,goto(1)}

fsm{wait(ev_pause_stop),Xstop,goto(1)}

try{Xstop}trap(ev_{—}[1]){notify(ev_Xstop_stop)}

Start elements fsm are integrated into

fsm{wait(start,

ev_play_end,

ev_play_stop,

ev_pause_stop),

Xstop,goto(1)

try{Xstop}trap(ev_{—}[1]) {notify(ev_Xstop_stop)}

Start element fsm and end element try are integrated into

fsm{wait(start,

ev_play_end,

ev_play_stop,

ev_pause_stop),

try{Xstop}trap(ev_{—}[1]) {notify(ev_Xstop_stop)}, goto(1)

}

[play]

fsm{wait(ev_Xstop_stop),play,goto(1) }
fsm{

try{fsm{play,notify(FINISH) }}

itrp(ev_[2]) {fsm{notify(ev_play_intrrupt),wait(ev_play_
resume) }}

trap(ev_[6]){notify(ev_play_stop) }
trap(FINISH) {notify(ev_play_end) },

goto (1)

}

End elements try are integrated, and end elements fsm are integrated with end element try as follows:

fsm{wait(ev_Xstop_stop),play,goto(1)}

fsm{

try{fsm{play,notify(FINISH)}}

itrp(ev_{—}[2]) {fsm{notify(ev_play_intrrupt),wait(ev_play_resume)}}

trap(ev_{—}[6]) {notify(ev_play_stop)}

trap(FINISH) {notify(ev_play_end)},

goto(1)

}

In addition, start element fsm and end element fsm are
integrated into

fsm{wait(ev_Xstop_stop),

try{fsm{play,notify(FINISH) }}

itrp(ev_[2]) {fsm{notify(ev_play_intrrupt),wait(ev_play_{—}
resume) }}

trap(ev_[6]) {notify(ev_play_stop) }
trap(FINISH) {notify(ev_play_end) },

goto (1)

}

pause

fsm{wait(ev_play_interrupt),pause,goto(1)}

try{pause}trap(ev_{—}[5]) {notify(ev_pause_stop_resume)}

try{pause}trap(ev_{—}[7]) {notify(ev_pause_stop)}

try{pause}trap(ev_{—}[4]) {notify(ev_pause_stop_resume)}

Elements try are integrated into

fsm{wait(ev_play_interrupt),pause,goto(1) }
try{pause}trap(ev_[5]) {notify(ev_pause_stop_resume) }

trap(ev_[7]){notify(ev_pause_stop) }
trap(ev_[4]){notify(ev_pause_stop_resume) }

Furthermore, start element fsm and end element try are
integrated into

fsm{wait(ev_play_interrupt),

try{pause}trap(ev_[5]) {notify(ev_pause_stop_resume) }

trap(ev_[7]) {notify(ev_pause_stop) }
trap(ev_[4]) {notify(ev_pause_stop_resume) },

goto (1)

}

OTHERS

The identical elements are integrated into one element as follows:

fsm{wait(ev_pause_stop_resume), notify(ev_play_resume), goto(1)}

FIG. 10 shows the specification in the system definition language form finally obtained.

The each function described above can be implemented as software.

In addition, this embodiment can be practiced as a program for causing a computer to execute predetermined means (or causing the computer to function as predetermined means or to realize predetermined functions) or a computer-readable recording medium on which the program is recorded.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A system design support method comprising:
generating a first system specification described in a state transition table form using a state transition unit which includes information relating to an execution control over the system;
generating a second system specification described in an execution control table form which includes an execution processing content in the system as a set of state transition units, based on the first system; and
converting the second system specification described in an execution control table form to a third system specification having an executable form described in a system description language.

2. The method according to claim 1, wherein each of the state transition units includes at least
a current state taken by the system,
an event serving as a cause of the state transition, and
a next state taken by the system upon occurrence of a state transition.

3. The method according to claim 2, wherein the state transition unit further includes
a condition that allows a state to make a transition, and
an action to be executed before a transition to a next state.

4. The method according to claim 1, wherein the information relating to the execution control includes
a program of which an execution control is triggered in association with the state transition and
a type of execution control over the program, the type of an execution control includes at least
a start of the system,
a forced termination of processing based on an interrupt caused by occurrence of an event,
a pause of processing based on an interrupt caused by occurrence of an event,
notification of an event which notifies that processing is ended, and
a resume from the pause of processing based on an interrupt.

5. The method according to claim 1, wherein the execution processing content includes at least
a transition that has occurred,
a program during execution,
a type of execution control to the program during execution,
a program to be executed next, and
a type of an execution control to the program to be executed next.

6. The method according to claim 1, wherein the converting comprises
expanding the execution processing content to a specification described in the system description language in accordance with the first rule; and
integrating the expanded specification in accordance with the second rule.

7. The method according to claim 6, wherein the system description language includes a specification description language based on C (SpecC).

8. A computer program product comprising:
a computer storage medium and a computer program code mechanism embedded in the computer storage medium for causing a computer to support designing, the computer code mechanism comprising:
a computer code device configured to generate a first system specification described in a state transition table form using a state transition unit which includes information relating to an execution control over the system
a computer code device configured to generate a second system specification described in an execution control table form which includes an execution processing content in the system as a set of state transition units, based on the first system; and
a computer code device configured to convert the second system specification described in an execution control table form to a third system specification having an executable form described in a system description language.

9. The computer program product according to claim 8, wherein the state transition unit includes at least
a current state taken by the system,
an event serving as a cause of the state transition, and
a next state taken by the system upon occurrence of a state transition.

10. The computer program product according to claim 8, wherein the state transition unit further includes
a condition that allows a state to make a transition, and
an action to be executed before a transition to a next state.

11. The computer program product according to claim 8, wherein the information relating to the execution control includes
a program of which an execution control is triggered in association with the state transition and
a type of execution control over the program, the type of an execution control includes at least
a start of the system,
a forced termination of processing based on an interrupt caused by occurrence of an event,
a pause of processing based on an interrupt caused by occurrence of an event,
notification of an event which notifies that processing is ended, and
a resume from the pause of processing based on an interrupt.

12. The computer program product according to claim 8, wherein the execution processing content includes at least
a transition that has occurred,
a program during execution,
a type of execution control to the program during execution,
a program to be executed next, and
a type of an execution control to the program to be executed next.

13. The computer program product according to claim 8 comprising a code device converting the first system specification described in the execution control table form to the third system specification having the executable form described in the system description language, the code device including:
a computer code device configured to expand the execution processing content to the specification described in the system description language in accordance with the first rule; and
a computer code device configured to integrate the expanded specification in accordance with the second rule;

14. The computer program product according to claim 8, wherein the system description language includes a specification description language based on C (SpecC).

15. A design support system comprising:
creating a system specification model comprised of a specification of a computation and a specification of a communication at a system level;
dividing and distributing partial structures of the system specification model into partial elements of a predetermined architecture to create an architecture model;
combining communication protocols between the partial elements of the architecture based on the specification of the communication to create a communication model;
associating the system specification model, the architecture model, and the communication model each other, and recording the associated model as a system specification;
generating a hardware specification from the system specification ;
generating a software specification from the system specification; and
generating a first system specification described in a state transition table form using a state transition unit which includes information relating to an execution control over the system;
generating a second system specification described in an execution control table form which includes an execution processing content in the system as a set of state transition units, based on the first system; and
converting the second system specification described in an execution control table form to a third system specification having an executable form described in a system description language.

16. The design support system according to claim 15, further comprising
forming a system specification model component in order to reuse the component in creating the system specification model, architecture model, and the communication model.

17. A computer program product comprising:
a computer storage medium and a computer program code mechanism embedded in the computer storage medium for causing a computer to support a designing, the computer code mechanism comprising:
a computer code device configured to create a system specification model comprised of a specification of a computation and a specification of a communication at a system level;
a computer code device configured to divide and distribute partial structures of the system specification model into partial elements of a predetermined architecture to create an architecture model;
a computer code device configured to combine communication protocols between the partial elements of the architecture based on the specification of the communication to create a communication model;
a computer code device configured to associate the system specification model, the architecture model, and the communication model, and to record the associated model as a system specification;
a computer code device configured to generate a hardware specification from the system specification;
a computer code device configured to generate a software specification from the system specification; and
a computer code device configured to generate a first system specification described in a state transition table form using a state transition unit which includes information relating to an execution control over the system;
a computer code device configured to generate a second system specification described in an execution control table form which includes an execution processing content in the system as a set of state transition units, based on the first system; and
a computer code device configured to convert the second system specification described in an execution control table form to a third system specification having an executable form described in a system description language.

18. The computer program product according to claim 17, further comprising
a computer code device configured to form a system specification model component in order to reuse the component in creating the system specification model, architecture model, and the communication model.
